(19) United States
(12) Patent Application Publication
(10) Pub. No.: US 2011/0106913 A1
(43) Pub. Date: May 5, 2011

(54) DYNAMICALLY MONITORING AND CUSTOMIZING DEVICES IN A COMMUNICATION NETWORK

(76) Inventor: Yaniv Cohen, Sderot (IL)

(21) Appl. No.: 13/002,517

(22) PCT Filed: Jul. 7, 2009
(86) PCT No.: PCT/IL2009/000679

§ 371 Date: Jan. 4, 2011

Related U.S. Application Data
(60) Provisional application No. 61/078,490, filed on Jul. 7, 2008.

(51) Int. Cl. G06F 15/16

(52) U.S. Cl. 709/217

(57) ABSTRACT

A data processing system for managing a communication network, comprising: a plurality of communication devices, each with a communication module; and a server arranged to communicate with the communication module of each of the communication devices via a communication link, the server comprising a plurality of applications, a plurality of interfaces and content. The server is arranged to provide each of the communication devices user selected applications, interfaces and content, responsive to user ad hoc selection and conditional upon user authentication. The communication device is arranged, and the applications, interfaces and content are selected, such that the communication device operates in response to selected applications, interfaces and content.

### BACKGROUND

1. Technical Field

The present invention generally relates to the field of mobile devices. More particularly, the present invention relates to software applications for mobile devices.

2. Discussion of Related Art

Conventional mobile devices include all operation relevant components in themselves, making them independent yet inflexible.

### BRIEF SUMMARY

Embodiments of the present invention provide a data processing system for managing a communication network, comprising: a plurality of communication devices, each with a communication module; and a server arranged to communicate with the communication module of each of the communication devices via a communication link, the server comprising a plurality of applications, a plurality of interfaces and content. The server is arranged to provide each of the communication devices user selected applications, interfaces and content, responsive to user ad hoc selection and conditional upon user authentication. The communication device is arranged, and the applications, interfaces and content are selected, such that the communication device operates in response to selected applications, interfaces and content. The data processing system virtualizes user selected characteristics of a predefined mobile device upon any of the communication devices.

Accordingly, according to an aspect of the present invention, there is provided a data processing system, wherein the server is further arranged to provide each of the communication devices with communication capabilities to at least one user selected cellular network.

Embodiments of the present invention provide a computer implemented method of customizing mobile devices, comprising: receiving authentication data from user; receiving user selections of application and content files; providing the user with the selected application and content files; and maintaining online communication for dynamic changing of user selections of application and content files. The computer implemented method virtualizes user selected characteristics of a predefined mobile device upon any of the mobile devices.

Accordingly, according to an aspect of the present invention, there is provided a computer implemented method, wherein providing the user with the selected application and content files comprises providing a generic mobile device with the selected application and content files such that the generic mobile device operates in response to selected application and content files.

Accordingly, according to an aspect of the present invention, there is provided a computer implemented method, wherein providing the user with the selected application and content files comprises removing applications and content files from a user mobile device and providing the user mobile device with the selected application and content files such that the user mobile device operates in response to selected application and content files.

Embodiments of the present invention provide a data processing system for customizing mobile devices, comprising: a server and a plurality of generic mobile devices. The server comprises databases (a first database comprising applications; a second database comprising content files; and a third database comprising user authentication data); and a service managing application. Each device comprises a display, a modem, a processor, and a memory unit. The generic mobile devices are connected via a communication link to the server. The server is arranged to provide each of the plurality of generic mobile devices a user selected combination of at least one application from the first database and at least one content file from the second database, responsive to user ad hoc selection and conditional upon user authentication utilizing the third database. The data processing system virtualizes user selected characteristics of a predefined mobile device upon any of the generic mobile devices.

Accordingly, according to an aspect of the present invention, there is provided a data processing system, wherein the at least one application configures the generic mobile device to be used for communication over a cellular network, and wherein exchanging the at least one application allows communication over a different cellular network.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the accompanying drawings of which:

FIG. 1 is a high level schematic block diagram illustrating data processing system for managing a communication network, according to some embodiments of the invention;

FIG. 2 is a high level schematic flowchart illustrating a computer implemented method of customizing mobile devices according to some embodiments of the invention; and

FIG. 3 is a high level schematic block diagram illustrating a data processing system for customizing mobile devices, according to some embodiments of the invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The present invention discloses a data processing system for and a computer implemented method of customizing mobile devices and operating them online from a remote server. The system and method allow a high level of virtualization of features of communication devices and further allows retrofitting communication devices.

In embodiments, all features, interfaces, memories, content and even operating systems of various types of communication enabled devices, such as mobile phones, personal digital assistants and networked computers, are supplied by either the communication provider or secondary firms, and may be emulated through communication on the particular devices. The system and method allows users to access the full technological space that surrounds them from their particular communication device. Communication device used in the system may be either generic devices or particular devices having their original interface, application etc. removed and adjusted to receive these from the system via communication.

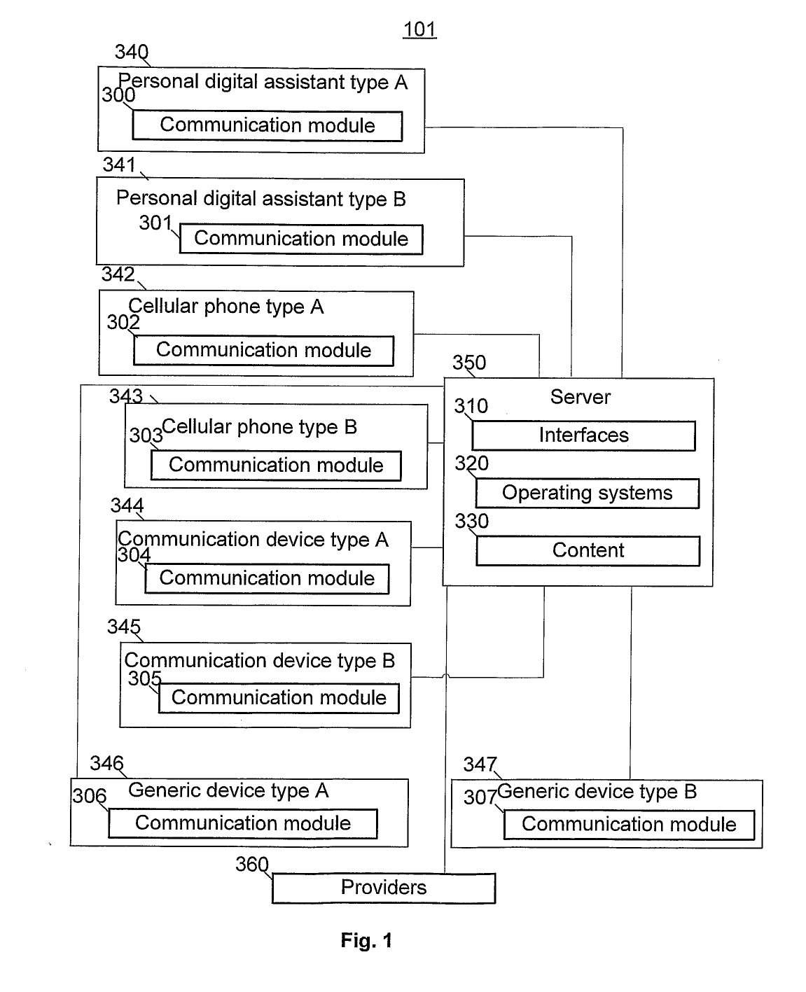

FIG. 1 is a high level schematic block diagram illustrating data processing system 101 for managing a communication network, according to some embodiments of the invention. Data processing system 101 comprises a server 350 connected via communication links to various communication devices 340, 341, 342, 343, 344, 345, 346, 347 having communication modules 300, 301, 302, 303, 304, 305, 306, 307, such as personal digital assistants (PDA's) 340, 341 of various types, cellular phones 342, 343 of various types and other communication devices of various types 344, 345 such as netbooks. Further communication devices may comprise generic devices 346, 347 of various types. Generic devices 346, 347 may be devices operable only with the selected applications, interfaces and content as supplied by server 350. Communication devices 340, 341, 342, 343, 344, 345, 346, 347 may comprise communication modules 300, 301, 302, 303, 304, 305, 306, 307, solely, and be devoid of any operating system, user interfaces, applications and content. These may be stored on server 350 and emulated on communication devices 340, 341, 342, 343, 344, 345, 346, 347 via communication modules 300, 301, 302, 303, 304, 305, 306, 307. Data processing system 101 virtualizes user selected characteristics of a predefined mobile device upon any of communication devices 340, 341, 342, 343, 344, 345, 346, 347.

Server 350 may comprise various interfaces 310, operating systems 320 and content 330 that may be emulated on communication devices 340, 341, 342, 343, 344, 345, 346, 347 according to user preferences in relation to each of communication devices 340, 341, 342, 343, 344, 345. Server 350 is arranged to provide each of communication devices 340, 341, 342, 343, 344, 345, 346, 347 user selected applications, interfaces and content, responsive to user ad hoc selection and conditional upon user authentication. Communication devices 340, 341, 342, 343, 344, 345, 346, 347 are arranged, and interfaces 310, operating systems 320 and content 330 are selectable such that communication devices 340, 341, 342, 343, 344, 345, 346, 347 operate in response to the selected applications, interfaces and content.

According to some embodiments of the invention, data processing system 101 allows a very flexible usage of communication devices 340, 341, 342, 343, 344, 345, 346, 347 including interchanges of interfaces and operating systems among communication devices 340, 341, 342, 343, 344, 345, 346, 347 regardless of the original settings of communication devices 340, 341, 342, 343, 344, 345. Indeed, communication devices 340, 341, 342, 343, 344, 345 may be user mobile devices with predefined applications, interface and content, from which the predefined applications, interface and content are removed and the selected applications, interface and content are emulated by server 350 via the communication link. Interfaces 310, operating systems 320 and content 330, as well as further applications, may be provided to server 350 or to communication devices 340, 341, 342, 343, 344, 345, 346, 347 directly by providers 360 that may or may not be affiliated with the communications provider operating server 350.

According to some embodiments of the invention, server 350 is further arranged to provide each of communication devices 340, 341, 342, 343, 344, 345, 346, 347 with communication capabilities and communication protocols to at least one user selected cellular network and to at least one user selected mobile phone standard. Server 350 may further be arranged to allow changing identification details, such as the dialing number, of the communication devices 340, 341, 342, 343, 344, 345, 346, 347 according to user preferences.

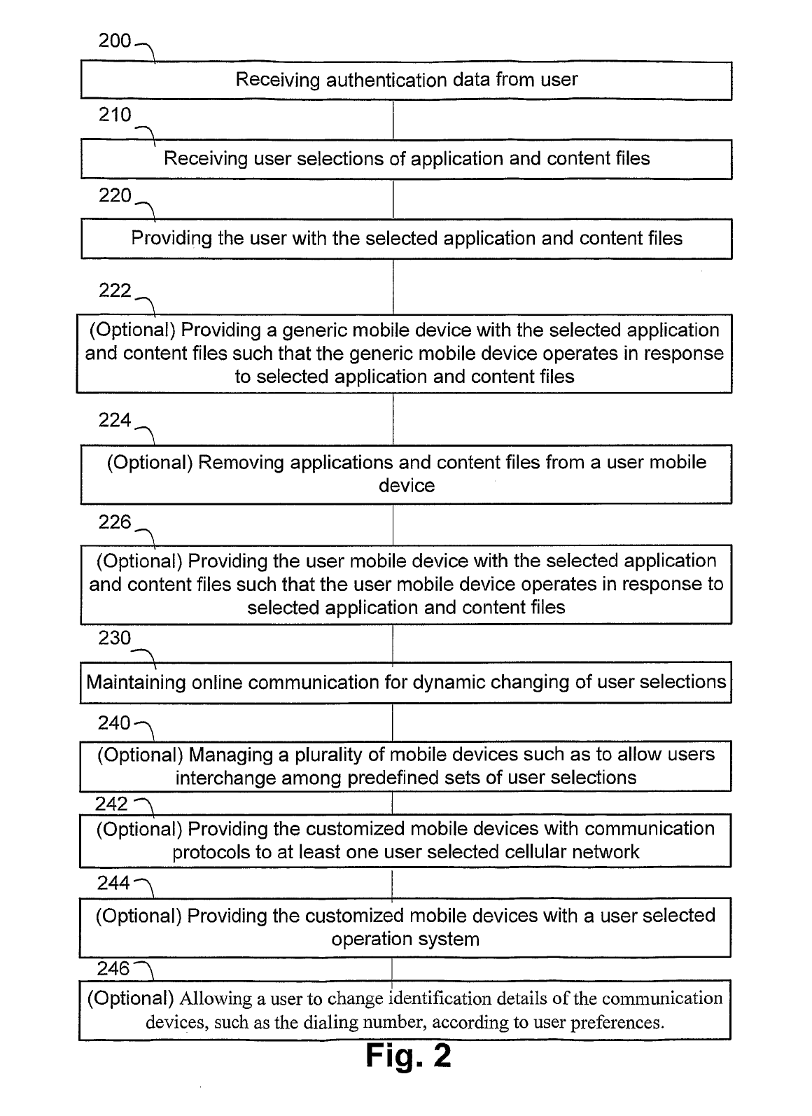

FIG. 2 is a high level schematic flowchart illustrating a computer implemented method of customizing mobile devices according to some embodiments of the invention. The computer implemented method comprises the following stages: Receiving authentication data from a user (stage 200); receiving user selections of application and content files (stage 210); providing the user with the selected application and content files (stage 220); and maintaining online communication for dynamic changing of user selections of application and content files (stage 230).

According to some embodiments of the invention, providing the user with the selected application and content files (stage 220) may comprise providing a generic mobile device with the selected application and content files such that the generic mobile device operates in response to selected application and content files (stage 222).

According to some embodiments of the invention, providing the user with the selected application and content files (stage 220) may comprise removing applications and content files from a user mobile device (stage 224) and providing the user mobile device with the selected application and content files such that the user mobile device operates in response to selected application and content files (stage 226).

According to some embodiments of the invention, the computer implemented method may further comprise managing a plurality of mobile devices such as to allow users interchange among predefined sets of user selections (stage 240).

According to some embodiments of the invention, the computer implemented method virtualizes user selected characteristics of a predefined mobile device upon any of the mobile devices.

According to some embodiments of the invention, providing the user with the selected application and content files (stage 220) may comprise providing the customized mobile devices with communication capabilities to at least one user selected cellular network (stage 242). According to some embodiments of the invention, providing the user with the selected application and content files (stage 220) may comprise providing the customized mobile devices with a user selected operation system (stage 244). According to some embodiments of the invention, providing the user with the selected application and content files (stage 220) may comprise providing the customized mobile devices with communication protocols to at least one user selected cellular network, or providing the customized mobile devices with communication protocols to at least one user selected mobile phone standard. According to some embodiments of the invention, the computer implemented method may further comprise allowing a user to change identification details of the communication devices, such as the dialing number, according to user preferences (stage 246).

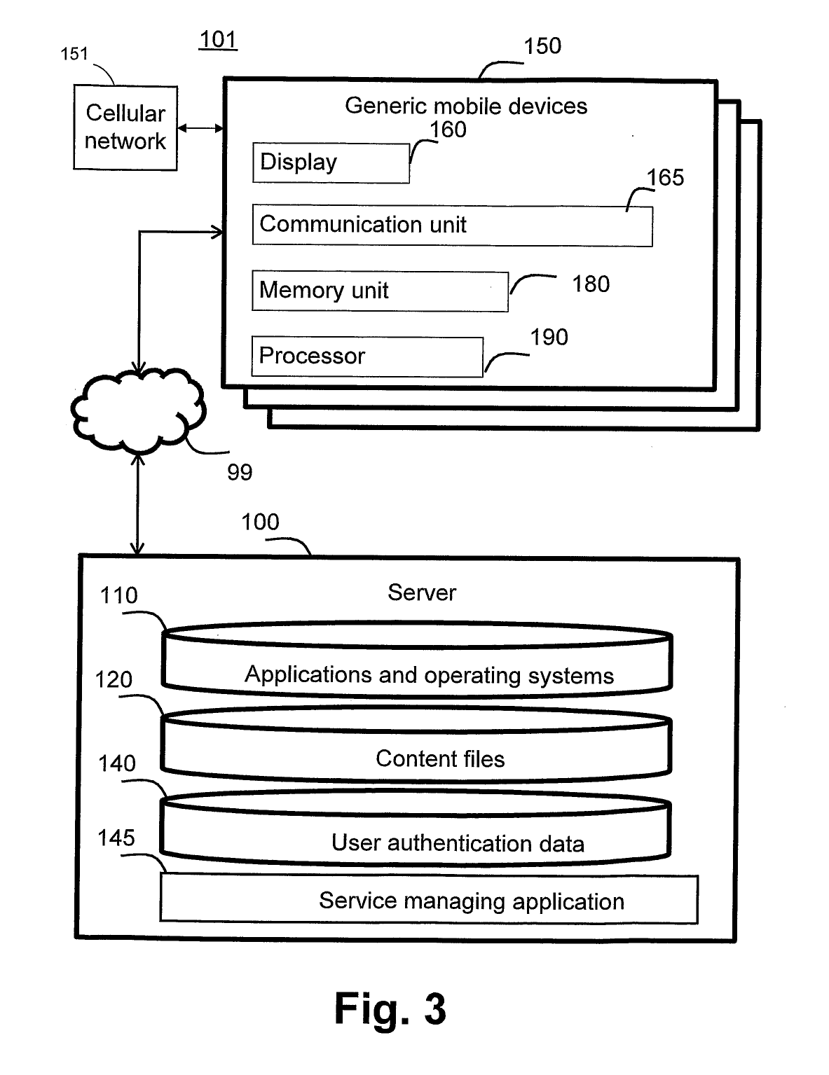

FIG. 3 is a high level schematic block diagram illustrating a data processing system 101 for customizing mobile devices, according to some embodiments of the invention. Data processing system 101 comprises a server 100 connected via a communication link 99 to a plurality of generic mobile devices 150. Server 100 comprises a first database 110 comprising applications, a second database 120 comprising content files, a third database 140 comprising user authentication data and a service managing application 145. Each of plurality of generic mobile devices 150 may but must not comprise an operation system, a display 160, a communication unit 165, a processor 190, and a memory unit 180. Server 100 is arranged to provide each of plurality of generic mobile devices 150 a user selected combination of at least one application and operating system from first database 110, (optionally an operating system as one of the applications), and at least one content file from second database 120, responsive to user ad hoc selection and conditional upon user authentication utilizing third database 140. Data processing system 101 virtualizes user selected characteristics of a predefined mobile device upon any of generic mobile devices 150. Generic mobile devices 150 may then be used for communication over a cellular network 151. Applications from first database 110 may comprise applications and protocols that enable generic mobile device 150 to various cellular networks 151 and exchanging these may allow the user to easily switch between cellular networks 151 and associated cellular providers. According to some embodiments of the invention, exchanging the application may allow communication with a different mobile phone standard. Applications may further be used to configure the generic mobile devices 150 to be used for communication with user selected identification details, such a selected dialing number.

According to some embodiments of the invention, mobile devices may comprise any device that may receive and transmit information, such as a cellular phone, a computer, a laptop, a personal digital assistant, an music player, a gaming console, a television, a radio, a digital camera, a cables control box, etc. Every mobile device may be generic and utilize the invention to enable a high flexibility in respect to software, interfaces, information components and any component that may be operated remotely.

According to some embodiments of the invention, applications may comprise software applications, hardware applications, applications for peripheral devices such as a memory card, and applications for processors and interfaces. Interface applications may be part of first database 110 or server 100 may comprise a separate database for interfaces.

According to some embodiments of the invention, service managing application 145 may manage the operation of the system and method, and be arranged to allow users to select, and then to provide generic mobile devices 150 with combinations of applications from first database 110 and content files from second database 120. Service managing application 145 may be arranged to respond to the user ad hoc selection of applications and content files. Service managing application 145 may manage the operation of the system and method according user authentication data such as passwords and permissions from third database 140.

Communication unit 165 may comprise a modem or any communication element enabling e.g. cellular, satellite or internet communication.

According to some embodiments of the invention, server 100 may allow remote operation of generic mobile devices 150 from any location and independently of the type of generic mobile device 150 itself. It allows universal use and ubiquitous coverage.

According to some embodiments of the invention, server 100 may comprise further elements and databases and provide generic mobile devices 150 with further components in remote operations. Server 100 may provide generic mobile devices 150 with a very large storage capacity, eliminating the need for storage on generic mobile devices 150 themselves. Server 100 may comprise processing elements operated remotely by generic mobile devices 150. The user may select ad hoc the processing elements operating on the generic mobile device 150. Different generic mobile devices 150 used by a single user may share or diverge in some or all of the elements provided by server 100.

According to some embodiments of the invention, the systems and method allows the user to interchange mobile devices without exchanging the physical apparatus. The user may interchange among user devices, switch user's and other's devices or user tailored devices by selecting interfaces, applications, operating system and content from the network provider or from other providers. The interchangeability encompasses all characteristics of the mobile device—applications, memory, processors, information cards and capabilities.

According to some embodiments of the invention, the systems and methods may emulate, or virtualize the operating system of the mobile device (generic 150 or other 340, 341, 342, 343, 344, 345, 346, 347) from server 100, thus allowing removing the necessity of having an operating system on the mobile device itself. This effect may be compared to using the mobile device as a terminal of the central server.

According to some embodiments of the invention, server 100 may lead calls to mobile device (generic 150 or other 340, 341, 342, 343, 344, 345, 346, 347) either over server 100, over the internet, or over any other network connected to it via a communication link.

According to some embodiments of the invention, the systems and methods sets minimal hardware requirements on the mobile devices (generic 150 or other 340, 341, 342, 343, 344, 345, 346, 347), that allow possible actions, but does not require any software component relating to the hardware.

According to some embodiments of the invention, the systems and methods may allow users exchange their telephone numbers over server 100, and thus practically switch devices (generic 150 or other 340, 341, 342, 343, 344, 345, 346, 347) in a virtual manner.

According to some embodiments of the invention, applications may be downloaded to any mobile device (generic 150 or other 340, 341, 342, 343, 344, 345, 346, 347) and may then be configured thereupon, or removed thereof in a dynamic manner, generating a completely virtual operation of the mobile devices themselves. Any application may be used on any mobile device, as long as the hardware supports it (e.g., a camera cannot be virtualized without the hardware). However, the mobile devices may comprise hardware designed to operate upon a wide variety of software applications.

According to some embodiments of the invention, data processing system 101 may be in communication with websites of providers and incorporate various advertising platforms that may be integrated in data processing system 101.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1-20. (canceled)

21. A remote server comprising:
a database of applications;
a database of content files;
a database of user authentication data; and
a service managing application,
wherein the server is arranged to communicate with a plurality of thin communication devices,
wherein the server is arranged to provide each communication device with a user selected combination of: (i) at least one application, (ii) at least one operating system from the database of applications, and (iii) at least one content file from the database of content files, responsive to user ad hoc selection, and conditional upon user authentication utilizing the database of user authentication data, and
wherein the system further virtualizes user selected characteristics of a predefined communication device upon any of the thin communication devices.

22. The remote server according to claim 21, wherein database applications comprising at least one application to configure the thin communication devices to adjust to: (i) a specified cellular network (ii) a specified cellular provider.

23. The remote server according to claim 22, wherein exchanging the application is arranged to adjust to a different standard of the communication device.

24. The remote server according to claim 22, wherein the database of applications comprising at least one application to configure the thin communication devices to be used for communication with user selected authentication details.

25. The remote server according to claim 24, wherein authentication details include a dialing number of the thin communication device.

26. A system for supporting communication devices with computing resources and communication capabilities, the system comprising:
a plurality of communication devices, each include a communication module;
a remote server, arranged to provide each of the communication devices with computing resources in response to user ad hoc selection and conditional upon a user authentication;
wherein the server communicates with each of the communication devices via a communication link, and
wherein the communication device is arranged to operate in response to data received from the server.

27. The system according to claim 26, wherein at least one of the communication devices is a thin device that is operable with selected computing resources, running on the server only.

28. The system according to claim 26, wherein at least one of the communication devices includes computing resources that are being removed as the communication device is connected to the server via a communication link.

29. The system according to claim 26, wherein the server is further arranged to provide each of the communication devices with communication protocols to at least one cellular network selected by a user.

30. A method of supporting communication devices with computing resources and communication capabilities, the method is comprising:
receiving authentication data from a user via a communication device;
receiving a list of selected computing resources from the user by a server;
providing the user selected computing resources by the server on the communication device; and
maintaining online communication for dynamic changing of computing resources selected by the user;

31. The method according to claim 30, wherein the providing is performed on a thin communication device, such that the thin communication device operates in response to the selected computing resources.

32. The method according to claim 30, wherein the providing comprises removing existing computing resources from the communication device and providing the communication device with computing resources selected by the user, such that the communication device operates in response to selected computing resources.

33. The method according to claim 30, further managing a plurality of communication devices such as to provide users with interchanging between specified sets of user selections of computing resources.

34. The method according to claim 30, wherein the providing is further comprises communication protocols to at least one cellular network, selected by the user.

35. The method according to claim 30, further providing the user with capabilities to change identification details of the communication device.

36. The method according to claim 30, the providing further comprising selecting an operating system, performed by the user.
